(19) United States
(12) Patent Application Publication
(10) Pub. No.: US 2025/0219308 A1
(43) Pub. Date: Jul. 3, 2025

(54) ELECTRICAL CONNECTOR STRUCTURE

(71) Applicant: Li Hong TECHNOLOGY SOLUTIONS CO., LTD., TAOYUAN CITY (TW)

(72) Inventor: Cheng-yang LI, TAOYUAN CITY (TW)

(21) Appl. No.: 19/002,847

(22) Filed: Dec. 27, 2024

(30) Foreign Application Priority Data
Dec. 29, 2023 (TW) 112151501

(51) Int. Cl. H01R 12/70

(52) U.S. Cl. CPC H01R 12/7005; H01R 12/7076

(57) ABSTRACT

An electrical connector structure, adapted for connecting an optoelectronic transceiver module on a mainboard, includes an interposer module and a fixing structure. The interposer module includes a first board and a second board assembled with each other, and at least a terminal module. A first terminal arm of the terminal module extends out of the first board, and a second terminal arm extends out of the second board. The fixing structure includes a pair of fixing walls, a plurality of first limiting members, and a second limiting member. The interposer module and the optoelectronic transceiver module are detachably arranged on the fixing structure and located on the mainboard, and the first limiting members press the second board, and the second limiting member presses the optoelectronic transceiver module, which in turn shortens a signal transmission path.

### CROSS REFERENCE TO RELATED APPLICATIONS

This application claims priority to Taiwan Patent Application No. 112151501, filed Dec. 29, 2023, the disclosure of which is incorporated herein by reference in its entirety.

### FIELD OF INVENTION

The present application relates to connectors, and more particularly to an electrical connector structure for connecting an optoelectronic transceiver module to a mainboard.

### BACKGROUND OF INVENTION

Using photons to replace electrons in integrated circuits for computing and using light as data transmission to meet the needs of high-capacity and high-speed signal transmission is an inevitable trend in the future. Currently, optical electronic integrated circuits have been developed, and co-packaging technology has been used to form optoelectronic transceiver components, which are suitable for high-performance data exchange, long-distance interconnection, 5G facilities, and computing equipment. However, current co-packaged optical transceiver components must be connected to motherboards via cables and connectors, which results in a relatively long signal transmission path and adversely affects transmission efficiency, the failure to fully fulfill the high transmission bandwidth density and high speed characteristics of the co-packaged optical transceiver components, and the difficult to repair and replace. Accordingly, it is imperative to improve the connection between current co-packaged optical transceiver components and motherboards.

### SUMMARY OF INVENTION

An object of the present application is to provide an electrical connector structure, which is capable of easily and quickly connecting an optoelectronic transceiver module to a mainboard and can shorten a signal transmission path.

Another object of the present application is to provide an electrical connector structure, which is conducive to repairing and replacing an optoelectronic transceiver module in terms of the assembly of the optoelectronic transceiver module and the mainboard.

To achieve the above-mentioned objects, the present application provides an electrical connector structure, adapted for connecting an optoelectronic transceiver module on a mainboard. The electrical connector structure comprises an interposer module and a fixing structure. The interposer module comprises at least a terminal module including a plurality of terminals. The fixing structure comprises a pair of fixing walls, a plurality of first limiting members, and a second limiting member. The pair of fixing walls are arranged on the mainboard and are spaced apart from each other to form an accommodation space, the first limiting members are arranged on the pair of fixing walls and protrude into the accommodation space, respectively, and the second limiting member is arranged above the first limiting members. The interposer module and the optoelectronic transceiver module are stacked in sequence and detachably arranged in the accommodation space, the first limiting members limit the interposer module on the mainboard, the second limiting member limits the optoelectronic transceiver module on the interposer module, and the optoelectronic transceiver module is electrically connected to the mainboard through the terminals of the interposer module.

Optionally, the interposer module further comprises a first board and a second board assembled with each other, and the terminal module is arranged between the first board and the second board and includes a terminal base and the plurality of terminals. Each of the terminals comprises a root portion, a first terminal arm, and a second terminal arm. The root portion is fixed to the terminal base, an end of the first terminal arm extends out of the first board, and an end of the second terminal arm extends out of the second board.

Optionally, the fixing structure further comprises a front limiting wall and a rear limiting wall, the front limiting wall and the rear limiting wall are connected between the pair of fixing walls, respectively, and form the accommodation space with the pair of fixing walls. The rear limiting wall comprises a pivot portion, and the second limiting member is pivotally connected to the pivot portion and rotates around the pivot portion as an axis to press against a top of the optoelectronic transceiver module or release the pressing force on the optoelectronic transceiver module.

Optionally, the front limiting wall comprises a pair of retaining portions arranged at a top of the front limiting wall, the second limiting member comprises a pair of pressing rods and a connecting rod connected between the pair of pressing rods, the connecting rod is pivotally connected to the pivot portion, an end of the pair of pressing rods away from the connecting rod can be movably retained in the pair of retaining portions, and the pair of pressing rods press the top of the optoelectronic transceiver module.

Optionally, each of the pressing rods comprises a manipulating portion extending out of the retaining portion by a preset distance.

Optionally, the pair of retaining portions of the front limiting wall have hook structures, respectively, and the end of the pair of pressing rods away from the connecting rod is movably retained in the hook structures of the retaining portions.

Optionally, the first terminal arm is inclined from the root portion toward a middle of the first board and the accommodation space, the second terminal arm is inclined from the root portion toward a middle of the second board and the accommodation space, and the first terminal arm and the second terminal arm are symmetrically arranged up and down relative to the root portion. The optoelectronic transceiver module presses against the end of the second terminal arm to cause the second terminal arm to move downward.

Optionally, the second terminal arm has an outwardly convex arc-shaped section with respect to the terminal base, the outwardly convex arc-shaped section extends from the root portion to the end of the second terminal arm, and the first terminal arm has an arc-shaped section that is the same as the arc-shaped section of the second terminal arm.

Optionally, the terminal base covers the root portion, and the terminals are aligned in a row and spaced apart from each other on the terminal base.

Optionally, the second board comprises a pair of side walls, which are spaced apart from each other, arranged at a top of the second board, and located close to and parallel to the pair of fixing walls of the fixing structure. Each of the side walls comprises a plurality of second positioning grooves arranged at a top of the side wall, respectively, and the first limiting members press against the corresponding second positioning grooves.

Optionally, the first board includes a plurality of first fastening portions, the second board includes a plurality of first engaging members, the plurality of first engaging members are detachably engaged with the plurality of first fastening portions, and a lower surface of the second board is attached to an upper surface of the first board.

Optionally, a lower surface of the second board comprises a plurality of positioning posts extending toward the first board, the first board comprises a plurality of through holes, the mainboard comprises a plurality of positioning holes, and the positioning posts pass through the through holes and are inserted into the positioning holes, respectively.

Optionally, the first board comprises a plurality of first positioning grooves, the pair of fixing walls comprise a plurality of fixing plates, which are arranged at a bottom of the pair of fixing walls and bent toward the accommodation space, respectively, and the fixing plates are inserted into the corresponding first positioning grooves.

Optionally, the first board comprises at least a terminal slot passing through an upper surface and a lower surface of the first board in a thickness direction, and the second board is detachably assembled on the first board and comprises at least a through slot arranged corresponding to and communicating with the terminal slot, the terminal base of the terminal module is disposed in the terminal slot and is located between the first board and the second board, and the end of the first terminal arm extends out of the terminal slot, and the end of the second terminal arm extends out of the through slot.

Optionally, the first board comprises a plurality of the terminal slots, each of the terminal slots extends in a short axis direction of the first board, and the plurality of terminal slots are arranged at intervals in a long axis direction of the first board.

Optionally, the electrical connector structure further comprises a protective cover removably covering a top of the interposer module.

Optionally, the pair of fixing walls comprise a plurality of limiting grooves arranged on a top edge of the pair of fixing walls, the opposite sides of the optoelectronic transceiver module comprise a plurality of limiting protrusions, and the limiting protrusions are detachably engaged with the limiting grooves.

Optionally, a bottom of the optoelectronic transceiver module comprises a positioning protrusion, the interposer module comprises a hollow portion, and the positioning protrusion is inserted into the hollow portion.

In the embodiments of the present application, the interposer module and the optoelectronic transceiver module of the electrical connector structure can be stacked in sequence by press-connection and detachably arranged in the fixing structure, and the first limiting members and the second limiting member are used to firmly press the interposer module and the optoelectronic transceiver module, respectively, so that the optoelectronic transceiver module can be installed to the electrical connector structure by simple press-connection, which in turn is directly electrically connected to the mainboard through the integrally formed terminal of the interposer module, so that the electrical signal from the optoelectronic transceiver module after photoelectric conversion can be transmitted to the mainboard, so as to fulfill the advantages of high capacity and high-speed transmission provided by the optoelectronic transceiver module, and shorten the transmission distance between the optoelectronic transceiver module and the mainboard, thereby effectively solving the problem that current co-packaged optical transceiver components must be connected to mainboards by cables and additional connectors, resulting in relatively longer transmission paths and difficult maintenance and replacement.

### BRIEF DESCRIPTION OF DRAWINGS

FIG. 1 is a schematic perspective assembly of an electrical connector structure and a mainboard according to an embodiment of the present application.

FIG. 2 is a schematic exploded view of the electrical connector structure of FIG. 1.

FIG. 3 is a schematic perspective exploded view of an interposer module according to an embodiment of the present application.

FIG. 4 is a flowchart of a manufacturing process of a terminal module according to an embodiment of the present application.

FIG. 5 is a partially enlarged schematic view of a terminal module according to an embodiment of the present application.

FIG. 6 is a schematic perspective exploded view of an electrical connector structure and an optoelectronic transceiver module according to an embodiment of the present application.

FIG. 7 is a schematic perspective assembly view of the electrical connector structure and the optoelectronic transceiver module of FIG. 6.

FIG. 8 is a top plan view of the electrical connector structure, the optoelectronic transceiver module, and the mainboard of FIG. 7.

FIG. 9 is a cross-sectional view taken along line A-A of FIG. 8.

FIG. 10 is a cross-sectional view taken along line B-B of FIG. 8.

FIG. 11 is a schematic perspective assembly view of the electrical connector structure and the optoelectronic transceiver module of FIG. 7 at a bottom-up perspective viewing angle.

FIGS. 12A to 12F are schematic views showing a process of connecting an optoelectronic transceiver module to an electrical connector structure through press-connection in an embodiment of the present application.

FIG. 13 is a schematic structural view showing the contact between terminals and an optoelectronic transceiver module in an embodiment of the present application.

FIG. 14 is a schematic view showing a usage state of an electrical connector structure according to an embodiment of the present application.

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

The following descriptions of the embodiments refer to the attached drawings to illustrate specific embodiments that can be used to implement the present application. Directional terms mentioned in this application, such as “up,” “down,” “front,” “back,” “left,” “right,” “top,” “bottom,” “horizontal,” “vertical,” etc., are only for reference to the directions of the accompanying drawings. Therefore, unless otherwise clearly specified and limited, the directional terms used are for explaining and understanding the present application, not for limiting the present application.

As used herein, unless otherwise specified, ordinal adjectives “first,” “second,” and “third,” etc. used herein to describe general objects merely indicate different instances of similar objects being referred to and are not intended to imply that the objects so described must be in a given order in time, space, in arrangement, or in any other manner.

In order to make the present application fully understood, the following description provides detailed steps and structures. Obviously, the implementation of this application will not be limited to the specific details known to those skilled in the art. In addition, the known structures and steps are not described in detail to avoid unnecessary limitation of the present application. It should be noted that, in the description of the present application, the functions or steps mentioned herein may appear in an order different from the order marked in the drawings. For example, two reference numbers displayed in succession may actually be executed substantially simultaneously or may sometimes be executed in reverse order, depending on the functions or steps involved.

An embodiment of the present application provides an electrical connector structure, adapted for connecting an optoelectronic transceiver module on a mainboard. In some embodiments, the optoelectronic transceiver module is an optoelectronic integrated circuit (OEIC) that integrates an electronic integrated circuit and a photonic integrated circuit, and uses co-packaged technology to form a co-packaged optics (CPO) transceiver module. Preferably, the optoelectronic transceiver module may include at least an optical detection component and a light source module, and a plurality of active components and passive components, such as but not limited to filters or multi-task structures, optical power distribution structures, optical fiber input and output structures, and optical modulation structures. Since the feature of the present application does not lie in the structure of the optoelectronic transceiver module known to those skilled in the art, its details are not described in detail here. In some embodiments, the optoelectronic transceiver module connected by the electrical connector structure of the present application has an architecture that complies with the 3.2 Tb/s co-packaged module implementation protocol specified by the Optical Internetworking Forum (OIF).

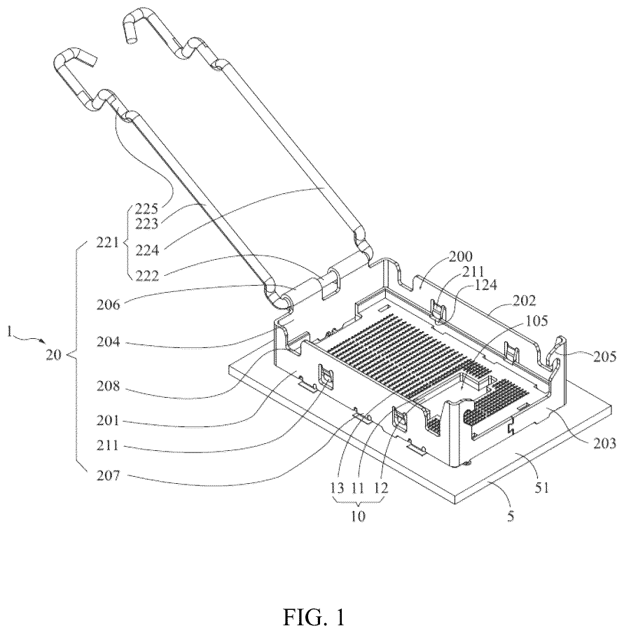

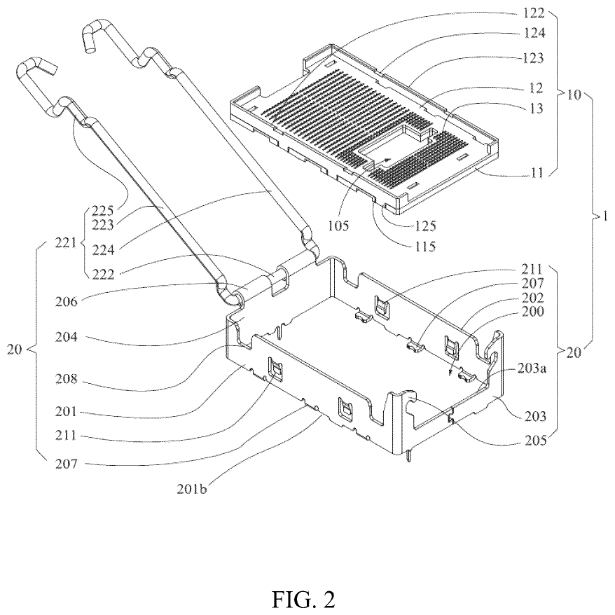

Referring to FIGS. 1 and 2, FIG. 1 is a schematic perspective assembly of an electrical connector structure 1 and a mainboard 5 according to an embodiment of the present application, and FIG. 2 is a schematic exploded view of the electrical connector structure of FIG. 1. As shown in FIG. 1, the present application provides the electrical connector structure 1, including an interposer module 10 and a fixing structure 20. In detail, the interposer module 10 includes a first board 11 and a second board 12 that can be assembled and detached from each other, and a plurality of terminal modules 13. Specifically, the second board 12 and the first board 11 are assembled in an up-and-down stacking manner. A plurality of terminal modules 13 are disposed between the first board 11 and the second board 12, and each terminal module 13 includes a terminal base 130 and a plurality of terminals 131. In some embodiments, each terminal 131 includes a root portion 132, a first terminal arm 133, and a second terminal arm 135. The root portion 132 is fixed to the terminal base 130, and an end 134 of the first terminal arm 133 extends out of the first board 11, and an end 136 of the second terminal arm 135 extends out of the second board 12.

Still referring to FIG. 1, the fixing structure 20 includes a pair of fixing walls 201 and 202, a front limiting wall 203, a rear limiting wall 204, a plurality of first limiting members 211, and a second limiting member 221. In detail, the front limiting wall 203 and the rear limiting wall 204 are connected between the front end and the rear end of the pair of fixing walls 201 and 202, and form a frame structure together with the pair of fixing walls 201 and 202, and can be fixed on a surface 51 of the mainboard 5 by, for example, surface adhesive technology, thereby forming an accommodation space 200. In this embodiment, the mainboard 5 is a circuit board on which one or more processors and electronic components (not shown) may be disposed, and is suitable for being a mainboard of a switch or a server, for example. In some embodiments, the fixing walls 201 and 202, the front limiting wall 203 and the rear limiting wall 204 can be made of a material with high hardness characteristics, such as metal, preferably stainless steel, and can be formed by a metal stamping process, but the above materials and fabrication methods are not limited thereto. As shown in FIGS. 1 and 2, the first limiting members 211 are integrally formed by stamping the fixing walls 201 and 202. Each of the first limiting members 211 protrudes toward the accommodation space 200 and forms a bevel 211a and a free end 211b, so that the first limiting members 211 can be displaced outward due to the pressing of external objects in the accommodation space 200. In this embodiment, as shown in FIG. 2, the fixing walls 201 and 202 include a plurality of fixing plates 207 and limiting grooves 208. Specifically, the limiting grooves 208 are formed at a top edge of the pair of fixing walls 201 and 202, and the fixing plates 207 are disposed at a bottom 201b of the pair of fixing walls 201 and 202 and are bent toward the accommodation space 200. In this embodiment, the fixing plates 207 can be fixed on the surface 51 of the mainboard 5 by using surface mounting technology.

As shown in FIG. 1 and FIG. 2, the interposer module 10 is detachably disposed on the mainboard 5. In detail, the interposer module 10 enters the accommodation space 200 downward from the top of the accommodation space 200 and interferes with and presses the bevels 211a of the first limiting members 211 on the two opposite sides of the accommodation space 200 during the downward movement, thereby pushing the first limiting members 211 to move outward. Finally, after the interposer module 10 passes the first limiting members 211, the first limiting members 211 return to their original position, and the free ends of the first limiting members 211 are pressed and fixed on the surface 51 of the mainboard 5. Through the above-mentioned press-connection method, the interposer module 10 can be firmly fixed on the mainboard 5, and the first terminal arm 133 contacts a corresponding conductive contact (not shown) of the mainboard 5. When the interposer module 10 is to be detached from the fixing structure 20, the first limiting members 211 can be pushed outwards of the accommodation space 200 to remove the interposer module 10.

It should be noted that in some other embodiments, the fixing structure 20 may only have the pair of fixing walls 201 and 202 without the front limiting wall 203 and the rear limiting wall 204. In some embodiments, the fixing walls 201 and 202 may utilize a diagonal bracing structure (not shown) supported on the mainboard 5 to enhance the structural strength. In some other embodiments, the fixing walls 201 and 202 may also be formed of a plurality of columnar structures (not shown). By the disposition of the fixing walls 201 and 202, the first limiting members 211 may also be used to press and fix the interposer module 10.

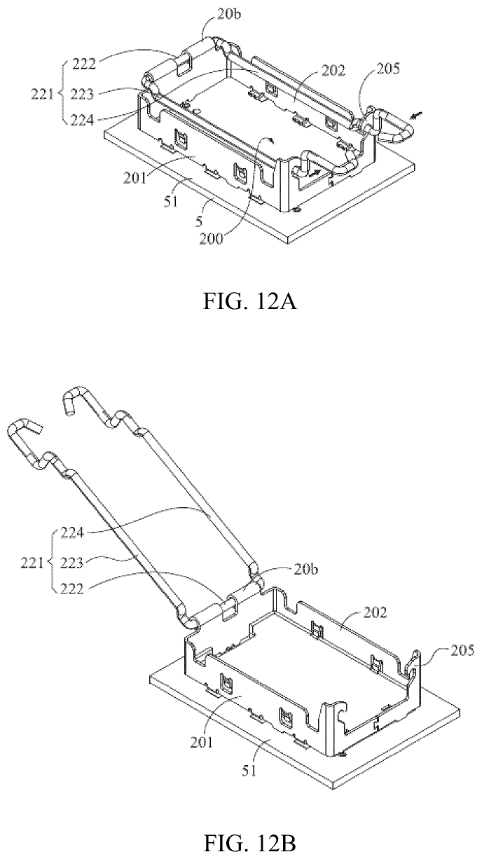

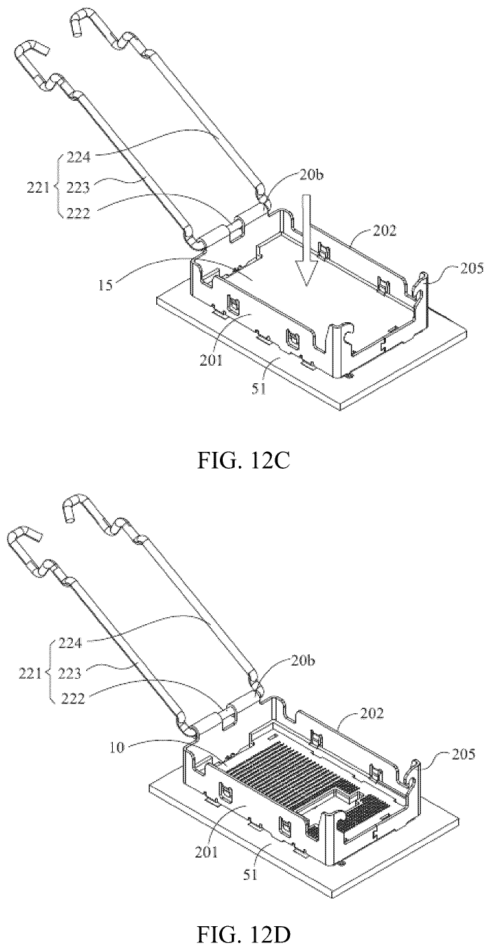

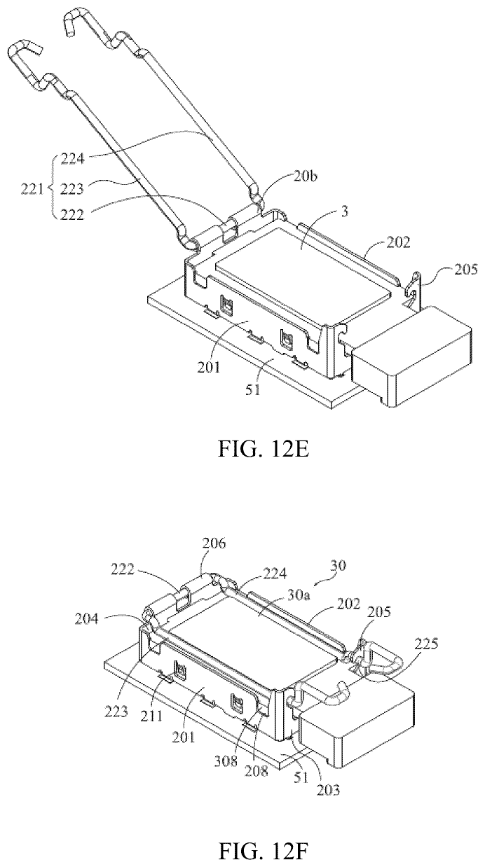

As shown in FIG. 2, the rear limiting wall 204 includes a pivot portion 206 having an axis hole, and the second limiting member 221 is pivotally connected to the pivot portion 206 and is disposed above the first limiting members 211. In detail, the front limiting wall 203 includes an opening 203a and a pair of retaining portions 205. The retaining portions 205 are disposed at a top of the front limiting wall 203 and located at two sides of the opening 203a. In some embodiments, the pair of retaining portions 205 each have a hook structure. As shown in FIG. 2, the second limiting member 221 includes a pair of pressing rods 223 and 224 and a connecting rod 222 connected between the pair of pressing rods 223 and 224. The pressing rods 223 and 224 are integrally formed with the connecting rod 222 to form a U-shaped structure, and the material of the second limiting member 221 may be the same as that of the fixing walls 201 and 202. In detail, the connecting rod 222 is pivotally connected to the pivot portion 206 and rotates around the pivot portion 206, thereby causing the pressing rods 223 and 224 to rotate in an open state (as shown in FIG. 2) or in a holding state (as shown in FIG. 12A) to press the optoelectronic transceiver module 3 or release the pressing force on the optoelectronic transceiver module 3 (as described later in detail). In some embodiments, the pressing rods 223 and 224 are configured to extend to the fixing walls 201 and 202, and each of the pressing rods 223 and 224 includes a manipulating portion 225, which extends out of the retaining portion 205 by a preset distance and is bent upward to facilitate the rotation of the pressing rods 223 and 224 between the open state and the holding state. When the pressing rods 223 and 224 are in the holding state, the ends of the pressing rods 223 and 224 away from the connecting rod 222 are movably held on the retaining portion 205 of the hook structure.

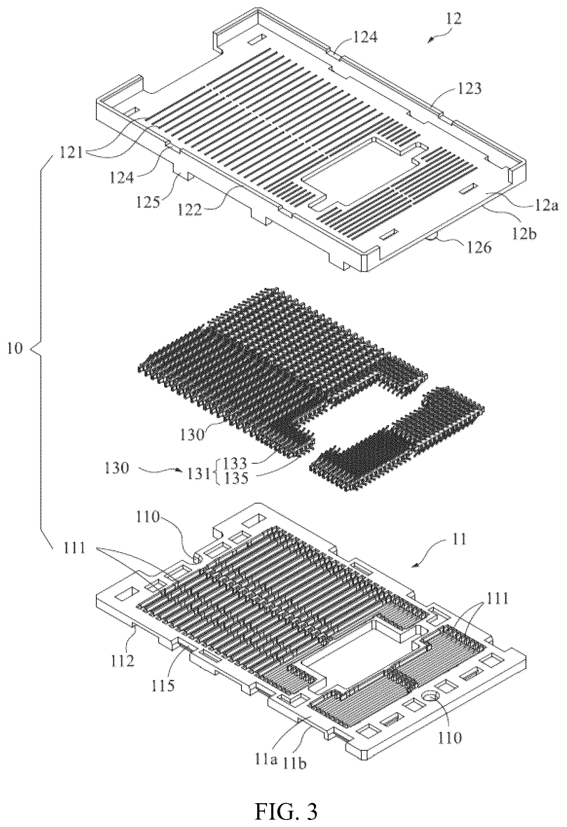

Referring to FIG. 3, FIG. 3 is a schematic perspective exploded view of the interposer module 10 according to an embodiment of the present application. As shown in FIG. 3, the first board 11 includes a plurality of terminal slots 111 and a plurality of first positioning grooves 112, and the plurality of terminal slots 111 pass through an upper surface 11a and a lower surface 11b of the first board 11 in a thickness direction. In detail, each terminal slot 111 extends in a short axis direction of the first board 11, and the terminal slots 111 are arranged at intervals in a long axis direction of the first board 11. The second board 12 is detachably assembled to the first board 11 and includes a pair of side walls 122 and 123 and a plurality of through slots 121. The plurality of through slots 121 are disposed corresponding to the terminal slots 111 and communicate with the terminal slots 111.

As shown in FIG. 3, the pair of side walls 122 and 123 are disposed at a top portion 12a of the second board 12 and are spaced apart from each other. The side walls 122 and 123 are located close to and parallel to the fixing walls 201 and 202, and each of the side walls 122 and 123 includes a plurality of second positioning grooves 124. The second positioning grooves 124 are disposed on a top of the side walls 122 and 123, respectively. In this embodiment, the first limiting members 211 press against the second positioning grooves 124, respectively, to fix the interposer module 10 on the mainboard 5 (as shown in FIG. 1). In addition, the fixing plates 207 of the fixing walls 201 and 202 are inserted into the corresponding first positioning grooves 112 to further limit the first board 11 in the longitudinal direction. As shown in FIGS. 2 and 3, the terminal base 130 of the terminal module 13 is disposed in the terminal slot 111 and located between the first board 11 and the second board 12, and the end 134 of the first terminal arm 133 extends out of the terminal slot 111, and the end 136 of the second terminal arm 135 extends out of the through slot 121.

Still referring to FIGS. 2 and 3, in some embodiments, the first board 11 includes a plurality of first fastening portions 115, the second board 12 includes a plurality of first fastening elements 125, and the first fastening elements 125 are detachably fastened with the first fastening portions 115. Preferably, each of the first fastening elements 125 is a hook protruding downward, and the first fastening portion 115 is a groove for the hook to be engaged. A bottom 12b of the second board 12 is attached to the upper surface 11a of the first board 11. The bottom 12b of the second board 12 includes a plurality of positioning posts 126 extending toward the first board 11. The first board 11 further includes a plurality of through holes 110, the mainboard 5 includes a plurality of positioning holes 510, and the positioning posts 126 pass through the through holes 110 and are inserted into the positioning holes 510, respectively, to further position the interposer module 10 on the mainboard 5.

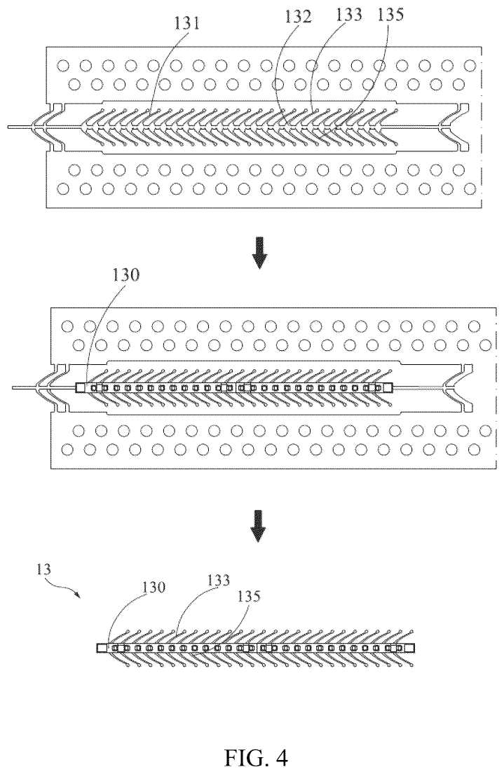

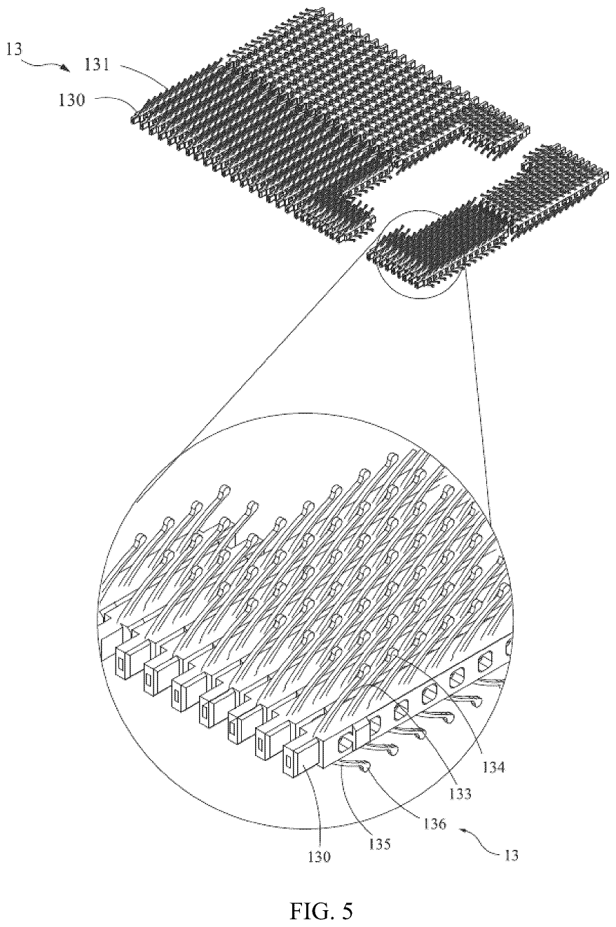

Referring to FIGS. 4 and 5, FIG. 4 is a flowchart of a manufacturing process of the terminal module 13, and FIG. 5 is a partially enlarged schematic view of the terminal module 13. The terminals 131 of the embodiment of the present application are fabricated by stamping a metal strip to form an integrally formed terminal structure. After the outline of the terminals 131 is stamped out, the terminal base 130 is formed on a row of terminals 131 through the insert molding process, and then the metal strip is cut to directly obtain the terminal base 130 combined with the row of terminals 131, thereby completing the formation of the terminal module 13. It should be noted that, since the interposer module 10 of the present application is configured with thousands of the terminals 131, and each terminal 131 is of a millimeter-level micro size, the difficulty of assembling the terminals and the terminal bases is greatly increased. The terminals 131 are directly integrally formed on the continuous metal strip through the above-mentioned stamping process, and then the terminals 131 are combined with the terminal base 130 using the insert molding process. The terminals 131 can be accurately and firmly fixed to the terminal base 130, effectively reducing the difficulty of assembly and being more conducive to the subsequent combination of the terminal module 13 and the terminal slot 111.

Still referring to FIGS. 4 and 5 in combination with FIG. 3, the first terminal arm 133 is inclined from the root portion 132 toward the terminal slot 111 of the first board 11 and a middle of the accommodation space 200, and the second terminal arm 135 is inclined from the root portion 132 toward the through slot 121 of the second board 12 and a middle of the accommodation space 200, and the first terminal arm 133 and the second terminal arm 135 are symmetrically arranged up and down relative to the root portion 132. In this embodiment, the second terminal arm 135 has an outwardly convex arc-shaped section with respect to the terminal base 130. The outwardly convex arc-shaped section extends from the root portion 132 to the end 136 of the second terminal arm 135. The first terminal arm 133 has an arc-shaped section that is the same as the arc-shaped section of the second terminal arm 135. The terminal base 130 covers the root portion 132, and the plurality of terminals 131 are aligned in a row and spaced apart from each other on the terminal base 130. In some embodiments, the ends 134 and 136 have a convex arc profile to facilitate contact with mating conductive contacts. It is noted that the second terminal arm 135 and the first terminal arm 133 can be deformed by a pressing force from an external object and can return to their original shape when the pressing force is released.

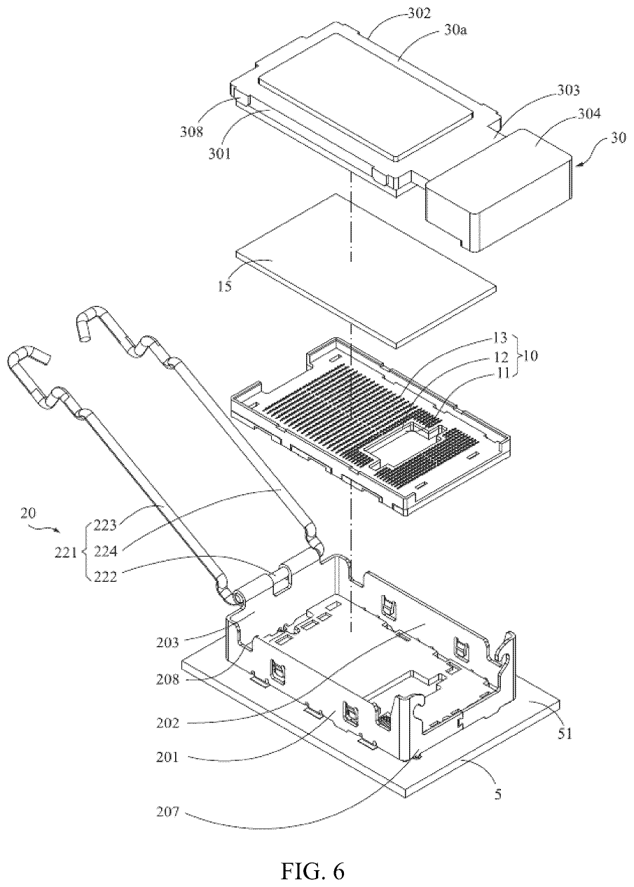

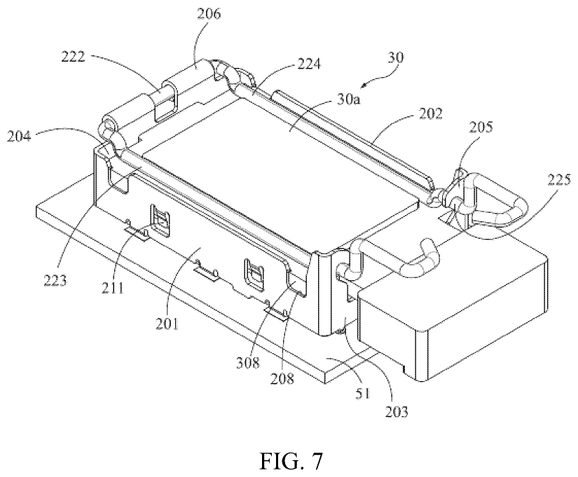

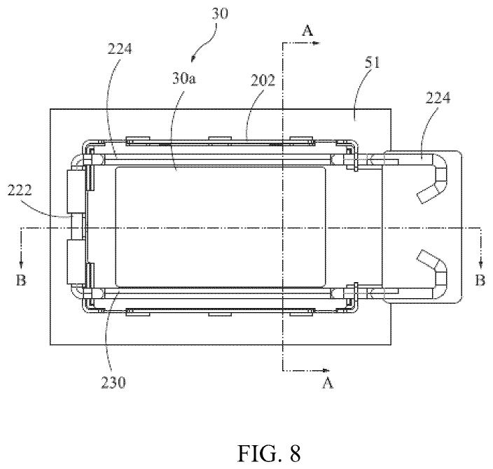

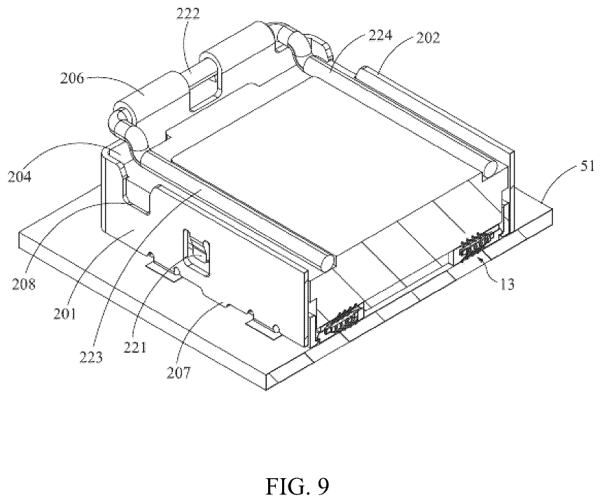

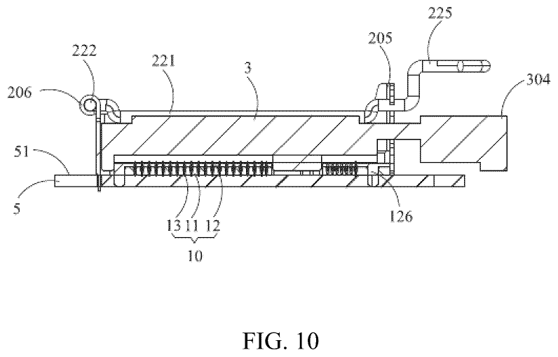

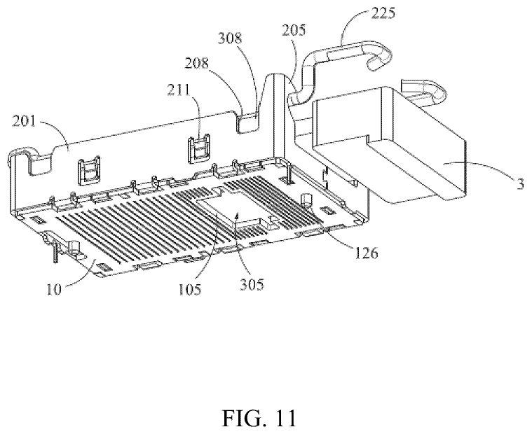

Referring to FIGS. 6 to 11, FIG. 6 is a schematic perspective exploded view of the electrical connector structure 1 and the optoelectronic transceiver module 3 according to an embodiment of the present application, FIG. 7 is a schematic perspective assembly view of the electrical connector structure 1 and the optoelectronic transceiver module 3 of FIG. 6, FIG. 8 is a top plan view of the electrical connector structure 1, the optoelectronic transceiver module 3, and the mainboard 5 of FIG. 7, FIG. 9 is a cross-sectional view taken along line A-A of FIG. 8, FIG. 10 is a cross-sectional view taken along line B-B of FIG. 8, and FIG. 11 is a schematic perspective assembly view of the electrical connector structure 1 and the optoelectronic transceiver module 3 of FIG. 7 at a bottom-up perspective viewing angle. As shown in FIG. 6, the electrical connector structure 1 of the embodiment of the present application further includes a protective cover 15, which is removably covered on the top 12a of the second board 12 to protect the exposed terminals 131 during the assembly process. In some embodiments, as shown in FIG. 6, the optoelectronic transceiver module 3 includes a top portion 30a, two opposite sides 301 and 302, a neck portion 303, a joint portion 304, and a plurality of engaging protrusions 308. In some embodiments, the joint portion 304 is used to connect a plurality of optical fibers (not shown) or cables (not shown) to transmit and receive optical signals or electrical signals. In detail, the engaging protrusions 308 are disposed on two opposite sides 301 and 302 of the optoelectronic transceiver module 3. After the interposer module 10 enters the accommodation space 200 and is fixed on the mainboard 5 by press-connection, the protective cover 15 is removed, and the optoelectronic transceiver module 3 is detachably disposed on the interposer module 10 by press-connection. At this time, the engaging protrusions 308 are detachably engaged with the limiting grooves 208 of the fixing walls 201 and 202 (as shown in FIG. 7).

As shown in FIGS. 9 and 10, after the optoelectronic transceiver module 3 is positioned through press-connection, the pressing rods 223 and 224 of the second limiting member 221 press against the top 30a of the optoelectronic transceiver module 3, and the bottom of the optoelectronic transceiver module 3 is located within the fixing walls 201 and 202, so that the optoelectronic transceiver module 3 is electrically connected to the mainboard 5 through the terminals 131 of the interposer module 10. As shown in FIG. 11, the bottom of the optoelectronic transceiver module 3 includes a positioning protrusion 305, and the interposer module 10 includes a hollow portion 105 (as shown in FIG. 2). The positioning protrusion 305 is inserted into the hollow portion 105 to further position the optoelectronic transceiver module 3 and the interposer module 10 on the mainboard 5.

Referring to FIGS. 12A to 12F, FIGS. 12A to 12F are schematic views showing a process of connecting the optoelectronic transceiver module 3 to the electrical connector structure 1 through press-connection. During connection, the fixing structure 20 is first assembled at a predetermined position of the mainboard 5 (as shown in FIG. 12A), and then the second limiting member 221 is opened to the open state (as shown in FIG. 12B). Next, the protective cover 15 is used to press the interposer module 10 from the top of the mainboard 5 downward to the accommodation space 200, so that the interposer module 10 is pressed against the surface 51 of the mainboard 5 through the first limiting members 211 (as shown in FIG. 12C). After the interposer module 10 is positioned, the protective cover 15 is removed (as shown in FIG. 12D). The optoelectronic transceiver module 3 is placed from top to bottom in the accommodation space 200 until the limiting protrusions 308 are engaged with the limiting grooves 208 (as shown in FIG. 12E). Finally, the second limiting member 221 is covered back to the holding state (as shown in FIG. 12F), and the pressing rods 223 and 224 are held at one end away from the connecting rod 222 in the retaining portions 205 of the hook structure. At this time, the pressing rods 223 and 224 press against the top 30a of the optoelectronic transceiver module 3, thereby completing the connection between the optoelectronic transceiver module 3 and the interposer module 10, so that the optoelectronic transceiver module 3 can be electrically connected to the mainboard 5 through the terminals 131 of the interposer module 10. Similarly, when the optoelectronic transceiver module 3 is to be taken out, the second limiting member 221 is opened to the open state through the manner opposite to the above steps to take out the optoelectronic transceiver module 3.

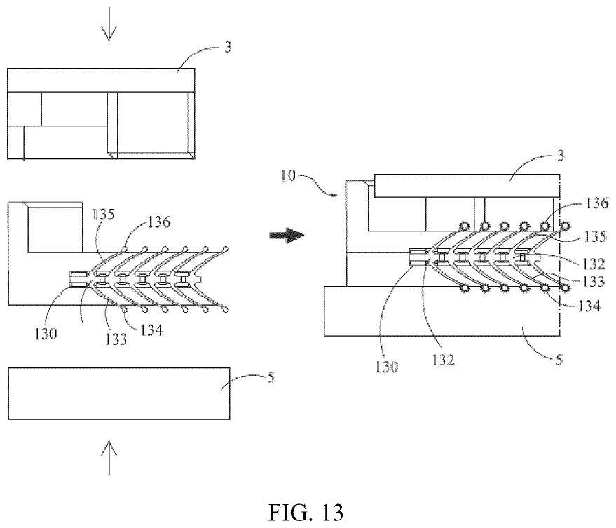

Referring to FIG. 13, FIG. 13 is a schematic structural view showing the contact between the terminals 131 and the optoelectronic transceiver module 3. As shown in FIG. 13, when the optoelectronic transceiver module 3 is pressed downward onto the second board 12, a conductive contact (not shown) at the bottom of the optoelectronic transceiver module 3 contacts the end 136 of the second terminal arm 135 and forces the second terminal arm 135 to move downward, so that each terminal 131 can be securely connected to the corresponding conductive contact.

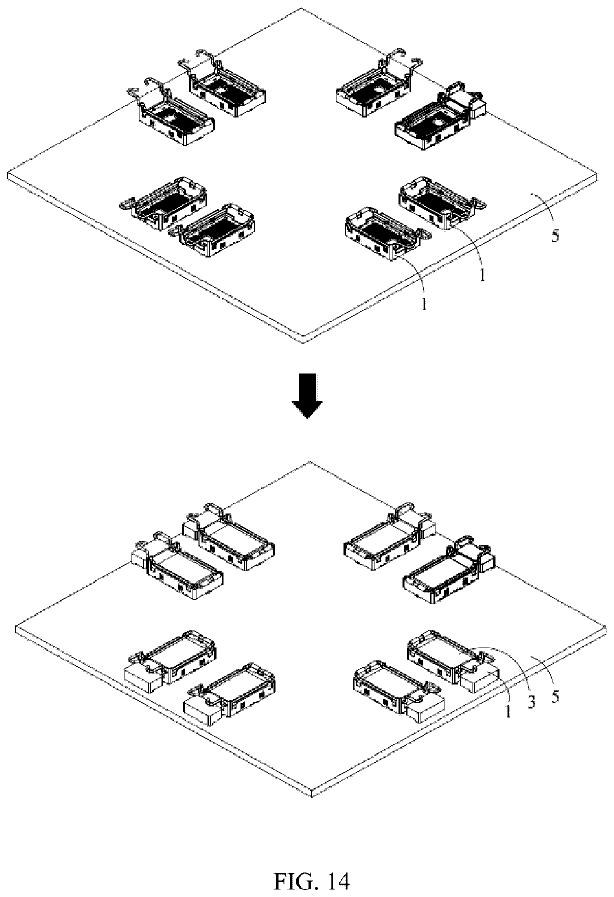

Referring to FIG. 14, it is a schematic view showing a usage state of the electrical connector structure 1 according to an embodiment of the present application. As shown in FIG. 14, a middle part of the mainboard 5 can be provided with electronic components such as a processor (not shown in the figures), and multiple sets of the electrical connector structures 1 and optoelectronic transceiver modules 3 can be configured around the mainboard 5, respectively. The actual number of sets of the electrical connector structures 1 and optoelectronic transceiver modules 3 is determined according to needs and is not particularly limited. Each optoelectronic transceiver module 3 is externally connected to a signal transmission component, such as an optical fiber or a cable (not shown). The above structure can be used to process high-capacity signal transmission and reception to meet the needs of high-speed and large-volume signal processing.

Accordingly, in the embodiments of the present application, the interposer module and the optoelectronic transceiver module of the electrical connector structure can be stacked in sequence by press-connection and detachably arranged in the fixing structure, and the first limiting members and the second limiting member are used to firmly press the interposer module and the optoelectronic transceiver module, respectively, so that the optoelectronic transceiver module can be installed to the electrical connector structure by simple press-connection, which in turn is directly electrically connected to the mainboard through the integrally formed terminal of the interposer module, so that the electrical signal from the optoelectronic transceiver module after photoelectric conversion can be transmitted to the mainboard, so as to fulfill the advantages of high capacity and high-speed transmission provided by the optoelectronic transceiver module, and shorten the transmission distance between the optoelectronic transceiver module and the mainboard, thereby effectively solving the problem that current co-packaged optical transceiver components must be connected to mainboards by cables and additional connectors, resulting in relatively longer transmission paths and difficult maintenance and replacement.

In the above embodiments, the description of each embodiment has its own emphasis. For parts that are not described in detail in a certain embodiment, reference can be made to the relevant descriptions of other embodiments.

The embodiments of the present application are introduced in detail above. Specific examples are used in this article to illustrate the principles and implementation methods of the present application. The description of the above embodiments is only used to help understand the technical solution and core idea of the present application. Ordinary technicians in this field should understand that they can still modify the technical solutions recorded in the aforementioned embodiments, or replace some of the technical features therein with equivalents; and these modifications or replacements do not make the essence of the corresponding technical solutions deviate from the scope of the technical solutions of the embodiments of the present application.

What is claimed is:

1. An electrical connector structure, adapted for connecting an optoelectronic transceiver module on a mainboard, and the electrical connector structure comprising:
an interposer module comprising at least a terminal module comprising a plurality of terminals; and
a fixing structure comprising a pair of fixing walls, a plurality of first limiting members, and a second limiting member, wherein the pair of fixing walls are arranged on the mainboard and are spaced apart from each other to form an accommodation space, the first limiting members are arranged on the pair of fixing walls and protrude into the accommodation space, respectively, and the second limiting member is arranged above the first limiting members, wherein the interposer module and the optoelectronic transceiver module are stacked in sequence and detachably arranged in the accommodation space, the first limiting members limit the interposer module on the mainboard, the second limiting member limits the optoelectronic transceiver module on the interposer module, and the optoelectronic transceiver module is electrically connected to the mainboard through the terminals of the interposer module.

2. The electrical connector structure of claim 1, wherein the interposer module further comprises a first board and a second board assembled with each other, and the terminal module is arranged between the first board and the second board and includes a terminal base and the plurality of terminals, wherein each of the terminals comprises a root portion, a first terminal arm, and a second terminal arm, the root portion is fixed to the terminal base, an end of the first terminal arm extends out of the first board, and an end of the second terminal arm extends out of the second board.

3. The electrical connector structure of claim 2, wherein the fixing structure further comprises a front limiting wall and a rear limiting wall, the front limiting wall and the rear limiting wall are connected between the pair of fixing walls, respectively, and form the accommodation space with the pair of fixing walls, wherein the rear limiting wall comprises a pivot portion, and the second limiting member is pivotally connected to the pivot portion and rotates around the pivot portion as an axis to press against a top of the optoelectronic transceiver module or release the pressing force on the optoelectronic transceiver module.

4. The electrical connector structure of claim 3, wherein the front limiting wall comprises a pair of retaining portions arranged at a top of the front limiting wall, the second limiting member comprises a pair of pressing rods and a connecting rod connected between the pair of pressing rods, the connecting rod is pivotally connected to the pivot portion, an end of the pair of pressing rods away from the connecting rod can be movably retained in the pair of retaining portions, and the pair of pressing rods press the top of the optoelectronic transceiver module.

5. The electrical connector structure of claim 4, wherein each of the pressing rods comprises a manipulating portion extending out of the retaining portion by a preset distance.

6. The electrical connector structure of claim 4, wherein the pair of retaining portions of the front limiting wall have hook structures, respectively, and the end of the pair of pressing rods away from the connecting rod is movably retained in the hook structures of the retaining portions.

7. The electrical connector structure of claim 2, wherein the first terminal arm is inclined from the root portion toward a middle of the first board and the accommodation space, the second terminal arm is inclined from the root portion toward a middle of the second board and the accommodation space, and the first terminal arm and the second terminal arm are symmetrically arranged up and down relative to the root portion, wherein the optoelectronic transceiver module presses against the end of the second terminal arm to cause the second terminal arm to move downward.

8. The electrical connector structure of claim 2, wherein the second terminal arm has an outwardly convex arc-shaped section with respect to the terminal base, the outwardly convex arc-shaped section extends from the root portion to the end of the second terminal arm, and the first terminal arm has an arc-shaped section that is the same as the arc-shaped section of the second terminal arm.

9. The electrical connector structure of claim 2, wherein the terminal base covers the root portion, and the terminals are aligned in a row and spaced apart from each other on the terminal base.

10. The electrical connector structure of claim 2, wherein the second board comprises a pair of side walls, which are spaced apart from each other, arranged at a top of the second board, and located close to and parallel to the pair of fixing walls of the fixing structure, wherein each of the side walls comprises a plurality of second positioning grooves arranged at a top of the side wall, respectively, and the first limiting members press against the corresponding second positioning grooves.

11. The electrical connector structure of claim 2, wherein the first board comprises a plurality of first fastening portions, the second board comprises a plurality of first fastening elements, the first fastening elements are detachably fastened with the first fastening portions, and a lower surface of the second board is attached to an upper surface of the first board.

12. The electrical connector structure of claim 2, wherein a lower surface of the second board comprises a plurality of positioning posts extending toward the first board, the first board comprises a plurality of through holes, the mainboard comprises a plurality of positioning holes, and the positioning posts pass through the through holes and are inserted into the positioning holes, respectively.

13. The electrical connector structure of claim 2, wherein the first board comprises a plurality of first positioning grooves, the pair of fixing walls comprise a plurality of fixing plates, which are arranged at a bottom of the pair of fixing walls and bent toward the accommodation space, respectively, and the fixing plates are inserted into the corresponding first positioning grooves.

14. The electrical connector structure of claim 2, wherein the first board comprises at least a terminal slot passing through an upper surface and a lower surface of the first board in a thickness direction, and the second board is detachably assembled on the first board and comprises at least a through slot arranged corresponding to and communicating with the terminal slot, the terminal base of the terminal module is disposed in the terminal slot and is located between the first board and the second board, and the end of the first terminal arm extends out of the terminal slot, and the end of the second terminal arm extends out of the through slot.

15. The electrical connector structure of claim 14, wherein the first board comprises a plurality of the terminal slots, each of the terminal slots extends in a short axis direction of the first board, and the plurality of terminal slots are arranged at intervals in a long axis direction of the first board.

16. The electrical connector structure of claim 1, further comprising a protective cover removably covering a top of the interposer module.

17. The electrical connector structure of claim 1, wherein the pair of fixing walls comprises a plurality of limiting grooves arranged on a top edge of the pair of fixing walls, opposite sides of the optoelectronic transceiver module comprise a plurality of limiting protrusions, and the limiting protrusions are detachably engaged with the limiting grooves.

18. The electrical connector structure of claim 1, wherein a bottom of the optoelectronic transceiver module comprises a positioning protrusion, the interposer module comprises a hollow portion, and the positioning protrusion is inserted into the hollow portion.
